(19) United States
(12) Patent Application Publication
(10) Pub. No.: US 2004/0053650 A1
(43) Pub. Date: Mar. 18, 2004

(54) Configurable mobile telephone

(76) Inventor: Michael John Roper, Warwickshire (GB)

Correspondence Address: Gottlieb Rackman & Reisman, 270 Madison Avenue, New York, NY, 10016-0601, US

(21) Appl. No.: 10/432,062

(22) PCT Filed: Nov. 19, 2001
(86) PCT No.: PCT/GB01/05170

(30) Foreign Application Priority Data
Nov. 18, 2000 (GB) 0028209.5
Aug. 1, 2001 (GB) 0118762.4

(51) Int. Cl. H04M 1/00

(52) U.S. Cl. 455/575.8

(57) ABSTRACT

An exchangeable cover (12, 14) for a mobile telephone (10) is configured to cover at least part of the mobile telephone. The cover itself may comprise an electronic memory (24) containing functionality or data which can be imparted to a mobile telephone core (16) via contacts (26, 28). The functionality or data contained within the electronic memory (24) is such as to influence operation of the application program embedded within the mobile telephone unit (16). In this way, at least some of the user interfaces of the mobile telephone (10) can be added to or modified by clipping on the exchangeable cover (12, 14) to the mobile telephone (10). The shape and/or patterning applied to the cover may have an association or theme in common with the functionality or data embedded within the electronic memory (24).

This invention relates exchangeable covers for mobile telephones and in particular but not exclusively to exchangeable covers which provide for the alteration of the physical appearance of the mobile telephone to which it is intended to be attached.

Generally, during the manufacture of known mobile telephone handsets, the various applications programs and associated resources necessary for operating the mobile telephone or handset are embedded together therein. The applications programs are provided with information relating to specific addresses in the device memory for locating and accessing respective resources.

It is known for mobile telephone handsets to be customisable, for example by way of interchangeable cosmetic covers which influence the physical appearance thereof. Moreover, it is also known in the art to modify the functionality of a mobile telephone by downloading ring tones, graphics and the like by way of WAP communication link or from the cellular telephone provider with which the mobile telephone user is associated. A problem with this is that each customisation is performed independently from the others which cannot only be time-consuming for the user but also somewhat limiting in the scope of customisations which may be implemented.

It is an aim of the invention to provide an arrangement whereby it is possible for a mobile telephone to be customised in a more convenient and comprehensive way.

According to the present invention there is provided an exchangeable cover for a mobile telephone, the exchangeable cover being dimensioned so as to cover at least part of the mobile telephone and comprising means for representing a functionality or data to be imparted to the mobile telephone, the functionality or data being usable by an application program embedded within the mobile telephone for influencing operation thereof, means for enabling the downloading of the new functionality or data to the mobile telephone, and means for locating the cover to the mobile telephone.

In one embodiment, the cover may comprise front and rear portions for respectively covering front and rear portions of the mobile telephone. These portions may be provided with fastening means for releasably fastening the front and rear portions together around the mobile telephone, there being means provided on either one or both of the portions for securing the mobile telephone within the cover.

In an alternative embodiment, the exchangeable cover may comprise engagement means for releasable engagement with the mobile telephone. The engagement means may be in the form of a “clip-on” arrangement.

The functionality or data may be such as to influence the “look and feel” of the mobile telephone from the point of view of how the user interacts with the device. The functionality or data may be any one or more of: an image or images for display by the mobile telephone; a ring tone or sequence; message; telephone number; software for modifying or adding to the functionality of the mobile telephone; new menu options; glyphs; text strings; audio files; WEB/WAP URL's etc. In addition, the functionality or data may be associated with the external appearance of the exchangeable cover. For example, the shape and/or patterning applied to the cover may have an association or theme in common with the functionality or data embedded within the cover. This theme may be anything from a favourite sports team, a famous person, company image and so on.

Embodiments of the invention have the advantage that basic telephone functionality may be provided in a core unit configured to receive thereon an exchangeable cover which comprises the representing means containing ancillary functions or data to be imparted to the mobile telephone such as to modify some or all of the user interfaces with the mobile telephone.

The shape or ornament applied to an exchangeable cover embodying the invention could be such as to relate to a corporate logo or sporting club livery. The functionality or data embedded within the representing means may contain information relevant to the corporate logo or club livery embodied in the appearance of the exchangeable cover itself. When the cover is attached to the core unit of the mobile telephone, the data or functionality contained within the cover is transferred to the telephone itself. The applications programs embedded therein recognise the input of new functionality or data and implement these during use while that cover is attached. It is envisaged, for example, that the data may include telephone numbers particular to the institution associated with the appearance of the exchangeable cover. Other information relating to that institution may be transferred and so be accessible by the user via the mobile telephone, for example, dedicated “hot keys”, corporate jingles or messages.

Embodiments of the invention may provide the possibility for product identification in cases where the functionality or data contains images or sounds related to a particular product or service. The functionality or data may be associated with a football team, merchandising program, banking, supermarket loyalty program, film launch or the like. The functionality may be such as to provide a new or modified game. The representative means may include information associated with a network operator so that the mobile telephone user can access helpline numbers, special logos, animations or other specific information relevant to the use of the telephone and the associated network. Further possibilities include additional or alternative languages for the telephone menus, these being interchangeable by the user simply replacing one exchangeable cover for a different one. When the mobile telephone is activated, an application program embedded therein is run to identify the presence of a new exchangeable cover and download the new functionality or data for use in subsequent mobile telephone operations.

It is envisaged that within the scope of the present invention different exchangeable covers may represent different “personalities” for the mobile telephone. For example, the user may have an exchangeable cover appropriate for domestic use in which case personal and domestic telephone numbers, games and other information of a personal nature may be stored within the representing means in the exchangeable cover. The appearance of the cover itself may be adorned with indicia of a recreational significance. The user may, at will, exchange this cover with one dedicated to his professional environment, containing professional telephone numbers, contact information and the like. In this case, the cover may be of a more muted appearance relative to the recreational one. In this way, the user is provided with the option of adapting his core telephone unit to the circumstances in which it is to be used. The representing means may be in the form of readable dataform embedded on or within the exchangeable cover, this being realised by an electronic memory. In this case, a communication interface comprising an electrical contact may be provided on the cover for engagement with a corresponding contact on the core mobile telephone. Alternatively, the readable dataform may comprise an optically readable bar code, optical sensing means being provided on the core.

The representing means may include a resource file comprising resource data defining one or more resources usable by the embedded applications program means for operating the user interface of the mobile telephone. The resource file may have a searchable structure. Resource files suitable for use in embodiments of the invention are the subject of co-pending International patent application based on British patent application numbers 0029209.4 and 0118762.4 filed on Nov. 18, 2000 and Aug. 1, 2001 respectively.

It is envisaged that it is within the scope of the invention for the representing and enabling means to be provided by way of profile formed on the cover for mechanical interaction with a corresponding sensor or switches provided on the mobile telephone.

The invention will be further described by way of example with reference to the accompanying drawings in which:

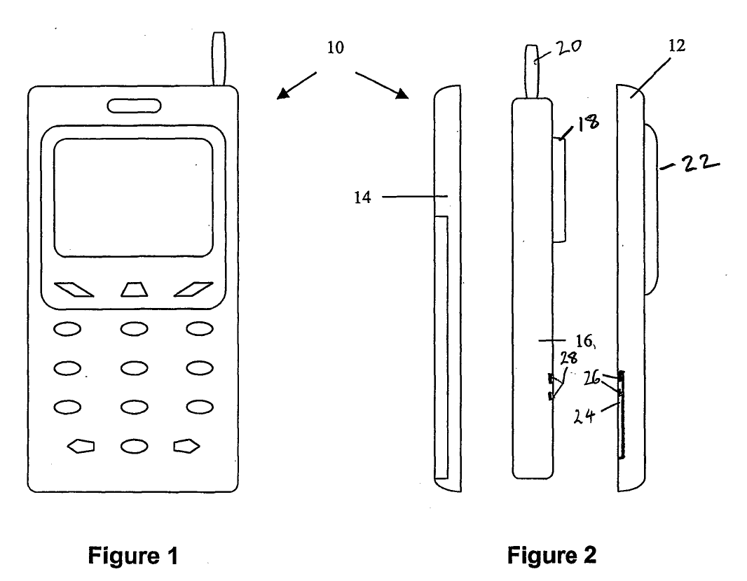

FIG. 1 is a front elevational view of a mobile telephone handset having an exchangeable cover thereon;

FIG. 2 is an exploded view of the cover used in the embodiment of FIG. 1;

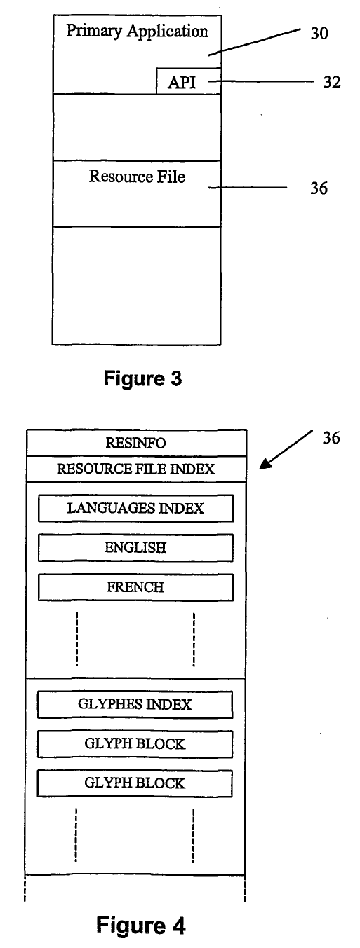

FIG. 3 is a representation of a memory of an electronic device for storing searchable resource file information;

FIG. 4 is a representation of a resource file for storage in the memory of FIG. 2; and

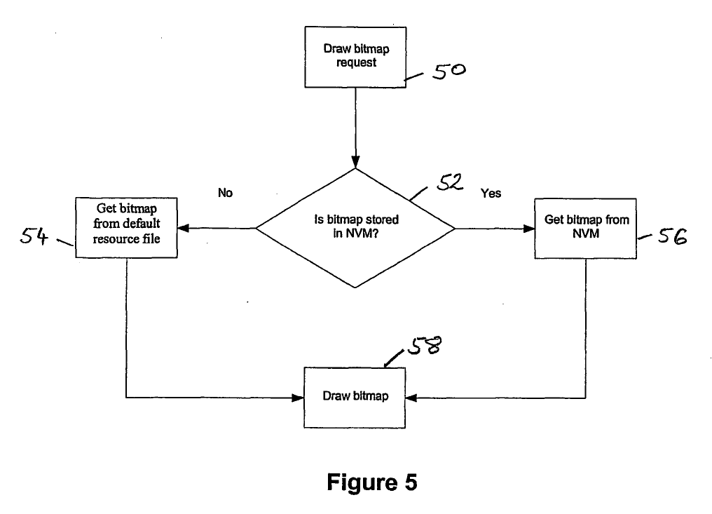

FIG. 5 is a diagram illustrating a process whereby the electronic device obtains resource information.

FIGS. 1 and 2 show a mobile telephone shown generally by the reference numeral 10. An exchangeable cover comprises front and rear portions 12 and 14 respectively which clip together around a mobile telephone core 16 which is operative to perform basic mobile telephone functionality. The core 16 includes a display 18 and antenna 20. The front and rear portions 12, 14 are provided with fastening means (not shown) which may consist of the edge portion of one portion being received by a corresponding recess in the other portion in a manner conventional in the art. The front portion includes a transparent window 22 through which the display of the core 16 can be viewed. A readable dataform consisting of an electronic memory 24 is provided within the front portion 12 and is electrically connected to contacts 26. The electronic memory 24 may be made up of more than one discrete memory component. The contacts make contact with connectors 28 disposed at corresponding locations on the core 16 so that when the first and second portions 12, 14 are fastened about the core 16, data contained within the electronic memory 24 can be accessed via the embedded application program.

In alternative embodiments (not shown) the exchangeable cover, which may be designed with a characteristic shape or pattern to define the cosmetic appearance of the telephone, may comprise only a front cover part or alternatively only a rear cover part. Furthermore, the cover parts may or may not enclose substantially all of the front and/or back of the core 16.

The electronic memory 24 can communicate with the application program or baseband components embedded in the core 16 when the mobile telephone 10 is in use. It may be part of the functionality of the application program of the core 16 to look for the presence of new functionality or data contained in the exchangeable cover whenever the mobile telephone is turned on or whenever the mobile telephone detects removal and subsequent application of an exchangeable cover.

The electronic memory 24 may be of any, known non-volatile memory type, such as flash memory, ROM, EEPROM, one time programmable (OTP) memory etc, and is capable of storing one or more resource files for the mobile telephone 10.

The resource file(s) is/are preferably stored in the electronic memory 24 prior to sale of the exchangeable cover to a user of the mobile telephone 10. However, the resource file(s) may alternatively and/or additionally be downloaded to the memory element from the mobile telephone 10 or from a computer.

The core 16 of the mobile telephone 10 comprises a processor and memory storage. Primary application code is stored in the memory storage of the core 16, and in use is run by the processor. The memory storage of the core unit 16 preferably also comprises resource file code.

FIG. 3 illustrates an example of a primary application code 30 and a resource file 36 located in the memory of the core 16. The primary application 30 includes an Application Program Interface (API 32). The resource file 36 is located separate to the primary application 30. The start address of the resource file 36 is known to the API 32. In one embodiment the resource file 36 is provided in a specific location in memory, whereby the start address is always known, and so the API 32 always knows where to look.

Where one or more further resource files are added, such as in the electronic memory 24 of the exchangeable cover, the resource file 36 becomes a default resource file. It is necessary for the API 32 to determine whether a particular resource is located in the default resource file 36 or in a subsequent resource file. In order to achieve this a lookup table is provided. The default resource file 36 is in general embedded in ROM, whilst any other resource files will be located in non-volatile memory (NVM) other than ROM. The lookup table contains associated IDs for resources contained in NVM. If the required resource is not located in the NVM then there will be no ID entry in the lookup table, and so the API 32 knows to obtain that particular resource from the default resource file 36.

FIG. 4 shows a schematic representation of the resource file 36 of FIG. 3, and the resource information contained therein.

In FIG. 5 an example is illustrated of a process for obtaining information contained in a bitmap resource, for generating a graphical display. A request is received at step 50 for a particular bitmap resource. The API 32 determines the relevant ID for the particular resource data, and then, at step 52, goes to a lookup table to determine whether the particular ID is located in the NVM which in this embodiment includes the electronic memory 24. If the resource ID is not present in the lookup table, then, at step 54, the API 32 retrieves the bitmap from the default resource file 36.

If however the resource ID is in the lookup table, the API 32 retrieves the bitmap from the resource file in the NVM at step 56. The lookup table may also include information about where the relevant resource file is located in the NVM, which will aid in differentiating between a plurality of resource files that could be locate in the NVM. At step 58 the graphical information in the bitmap is used to generate a display.

In the above illustrated example the resource file(s) in the memory element of the exchangeable cover is accessed directly each time one of the resources is required. However, the resource in the memory element of the exchangeable cover may alternatively be accessed only when the phone is switched on, or as mentioned above when the exchangeable cover is first attached to the core 16, with the resource file(s) being copied/transferred to an area of memory within the core 16.

Where the resource file is copied or transferred to an area of memory of the core 16, the resource file in the electronic memory 24 may be compressed and/or encoded. When the resource file is copied or transferred, it may be decompressed and/or decoded.

1. An exchangeable cover for a mobile telephone, the exchangeable cover being dimensioned so as to cover at least part of the mobile telephone and comprising means for representing a functionality or data to be imparted to a mobile telephone useable by an application program embedded within the mobile telephone for influencing operation thereof, means for enabling the downloading of the new functionality or data to the mobile telephone, and means for locating the cover to the mobile telephone.

2. An exchangeable cover according to claim 1 wherein the cover comprises front and rear portions for respectively covering front and rear portions of the mobile telephone.

3. An exchangeable cover according to claim 2, wherein the front and rear portions are provided with fastening means for releasably fastening the front and rear portions together around the mobile telephone.

4. An exchangeable cover according to claim 3, wherein means are provided on either one or both of the front and rear portions for securing the mobile telephone within the exchangeable cover.

5. An exchangeable cover according to claim 1, wherein the exchangeable cover comprises engagement means for releasable engagement with the mobile telephone.

6. An exchangeable cover according to any one of the preceding claims, wherein the functionality or data is any one or more of: an image or images for display by the mobile telephone; a ring tone or sequence; message; telephone number; software for modifying or adding to the functionality of the mobile telephone.

7. An exchangeable cover according to any one of the preceding claims wherein the functionality or data is associated with the external appearance of the exchangeable cover.

8. An exchangeable cover according to any one of the preceding claims wherein the means for representing the functionality or data comprises a readable dataform embedded on or within die exchangeable cover.

9. An exchangeable cover according to claim 8, wherein the readable dataform comprises an electronic memory.

10. An exchangeable cover according to claim 9, wherein the communication means comprises an electrical contact for engaging with a corresponding electrical contact on the mobile telephone thereby providing electrical contact between the electronic memory and the mobile telephone.

11. An exchangeable cover according to claim 8, wherein the readable dataform comprises an optically readable barcode.

12. An exchangeable cover according to any one of claims 1 to 7, wherein the representing means and the enabling means are provided by a profile formed on the cover for mechanical interaction with a corresponding sensor provided on the mobile telephone.

13. An exchangeable cover according to any one of the preceding claims wherein the representing means comprises a resource file comprising resource data defining one or more resources usable by the embedded application program means for operating a user interface of the mobile telephone.

14. An exchangeable cover according to claim 13, wherein the resource file has a searchable structure.

15. An exchangeable cover according to any one of the preceding claims and mobile telephone combination, wherein said functionality or data represented by said representing means is ancillary to the mobile telephone.

16. A kit of parts comprising one or more exchangeable covers according to any one of the preceding claims and a mobile telephone configured to exchangeably receive said one or more covers.
